(19) United States
(12) Patent Application Publication
(10) Pub. No.: US 2023/0024380 A1
(43) Pub. Date: Jan. 26, 2023

(54) CELL WITH METALLIC LITHIUM ANODE AND PRODUCTION METHOD

(71) Applicant: VARTA Innovation GmbH, Graz (AT)

(72) Inventor: Stefan Koller, Ragnitz (AT)

(21) Appl. No.: 17/785,618

(22) PCT Filed: Dec. 4, 2020
(86) PCT No.: PCT/EP2020/084730

§ 371 Date: Jun. 15, 2022

(30) Foreign Application Priority Data
Dec. 18, 2019 (EP) 19217698.0

(51) Int. Cl. H01M 10/052; H01M 4/80; H01M 50/46; H01M 4/38; H01M 4/62; H01M 4/04; H01M 4/66

(52) U.S. Cl. CPC H01M 10/052; H01M 4/808; H01M 50/46; H01M 4/382; H01M 4/625; H01M 4/0404; H01M 4/661; H01M 2004/027

(57) ABSTRACT

An electrochemical cell includes a. a cathode capable of reversibly accommodating lithium ions; b. an anode containing metallic lithium as active material; and c. a separator arranged between the cathode and the anode, wherein d. the anode includes a porous, electrically conductive matrix having an open-pored structure; and e. the metallic lithium of the anode is incorporated in pores of the matrix.

### TECHNICAL FIELD

This disclosure relates to a cell having a metallic lithium anode and a process of producing such a cell.

### BACKGROUND

A known example of a cell having a metallic lithium anode is the lithium-sulfur cell. Like any other electrochemical cell capable of storing electrical energy, that cell comprises a cathode and an anode as electrodes and a separator arranged between the cathode and the anode, wherein the cathode contains sulfur as active material and the anode contains lithium as active material.

During discharging of a lithium-sulfur cell lithium is oxidized at the anode. At the cathode the lithium combines with sulfur to form lithium sulfides, dilithium sulfide Li₂S in complete discharging, for example, according to the formula:

S₈+16Li→8Li₂S.

During the charging operation, lithium sulfides formed are re-dissolved. Sulfur is formed on the cathode side and lithium on the anode side, for example, according to the formula:

8Li₂S→S₈+16Li.

However, metallic lithium anodes can also be combined with cathodes capable of reversibly incorporating lithium in ionic form, for example, with cathodes based on lithium cobalt oxide (LCO), nickel manganese cobalt (NMC) or lithium iron phosphate (LFP).

One of the problems that has so far prevented marketability of cells having a metallic lithium anode results from the fact that such anodes are completely decomposed in complete discharging. That is to say the volume of the anodes can go to zero during discharging. This results in massive volume changes within the cell, which are repeated in the opposite direction upon charging.

The problem is critical especially when the cells have a construction where several anodes and cathodes in layer form are stacked in alternating sequence. In that instance, the respective volume changes are added together.

DE 102014 201836 A1 describes a lithium-sulfur cell in which the problem is countered with volume compensation elements intended to compensate for the changes in volume during charging and discharging of the cell. The volume compensation elements are elastic and installed in the cell in addition to the electrodes. Volume changes within the cell can cause them to be compressed or expand as required. They exert a continuous pressure on the electrodes.

The disadvantage of that approach is that the installed volume compensation elements represent dead material from an electrochemical standpoint and adversely affect the volumetric energy density of a cell provided therewith. Their installation also represents an additional step in the manufacture of lithium-sulfur cells that represent an additional source of faults in a highly automated production process.

It could therefore be helpful to provide cells having a metallic lithium anode that are improved relative to known cells.

### SUMMARY

I provide an electrochemical cell including:

a. a cathode capable of reversibly accommodating lithium ions;
b. an anode containing metallic lithium as active material; and
c. a separator arranged between the cathode and the anode, wherein
d. the anode includes a porous, electrically conductive matrix having an open-pored structure; and
e. the metallic lithium of the anode is incorporated in pores of the matrix.

I also provide a process of producing the electrochemical cell including:

a. providing a porous, electrically conductive matrix;
b. incorporating lithium in pores of the matrix to form an anode containing the lithium as active material; and
c. combining the anode formed with a separator and a cathode containing sulfur as active material.

### BRIEF DESCRIPTION OF THE DRAWINGS

FIG. 1 is a graph showing cycle number versus capacity.

FIG. 2 is a schematic diagram of an example of an electrical cell.

### DETAILED DESCRIPTION

My cells always comprise:

a. a cathode capable of reversibly accommodating lithium ions;
b. an anode containing metallic lithium as active material; and
c. a separator arranged between the cathode and the anode, wherein
d. the anode comprises a porous, electrically conductive matrix having an open-pored structure; and
e. the metallic lithium of the anode is incorporated in pores of the matrix.

The electrically conductive matrix is a central feature of my cells. This is because it ensures that at least on the anode side the described volume changes during charging and discharging of the cell are minimized.

Starting from a charged state in which the lithium is disposed at least predominantly, optionally completely, in the pores of the cell, discharging causes the lithium to be decomposed in the anode. However, in contrast to known cells, the anode loses virtually no volume since this is determined essentially by the matrix. During charging, the lithium can then be uniformly redeposited in the anode as a consequence of the electrical conductivity of the matrix. Nonuniform lithium depositions and associated local volume increases or even dendrite formations may therefore be avoided.

The cathode of the cell may be a cathode containing sulfur as active material. The cell may therefore be a lithium-sulfur cell. For example, the cathode may comprise a mixture of sulfur with an addition to improve electrical conductivity, for example, from the group comprising graphite, carbon black, CNT and graphene. However, the cathode may also contain the sulfur in chemically modified form, for example, as polysulfide.

Further preferably, the cathode comprises as active material a compound capable of reversibly incorporating the lithium in ionic form. For example, the cathode may contain as active material lithium cobalt oxide (LCO), layered oxides such as nickel manganese cobalt oxide (NMC), polyanionic compounds such as lithium iron phosphate (LFP) or spinel compounds such as lithium manganese spinel.

The anode comprises the lithium in metallic form. It may optionally also comprise a further material, for example, at least one metal with which the lithium is alloyed. At least one further material is optionally likewise incorporated in the pores of the matrix.

The separator ensures that the cathode and the anode are spatially and electrically separated from one another. The separator is preferably a porous fabric, in particular, a porous film or a fleece or a felt or a textile fabric. The separator is preferably manufactured from a plastic, for example, from a polyolefin, a polyimide or a polyester.

The cell preferably comprises a liquid electrolyte consisting of a solvent or solvent mixture and a lithium-ion-containing conducting salt. Suitable conducting salts include, for example, lithium bis(trifluoromethanesulfonyl)imide (LiTFSI) or lithium hexafluorophosphate (LiPF₆) or lithium tetrafluoroborate (LiBF₄). Suitable solvents include, for example, organic carbonates, in particular, ethylene carbonate (EC), propylene carbonate (PC), 1,2-dimethoxyethane (DME), ethyl methyl carbonate (EMC), dimethyl carbonate (DMC) or diethyl carbonate (DEC) and mixtures thereof.

When the cell is a lithium-sulfur cell, the solvent used may be a mixture of dioxolane (DOL) and the DME, for example. The electrolyte may additionally contain a passivation additive such as lithium nitrate (LiNO₃).

However, as an alternative to a separator/liquid electrolyte combination, the cell may also contain a polymeric electrolyte, an ionic liquid or a solid state electrolyte.

The polymer electrolyte may especially be a gel electrolyte, for example, based on polyvinylidene fluoride-polyhexafluoropropylene copolymer (PVDF-HFP).

Ionic liquids (ILs) are salts of an organic nature characterized by the steric asymmetry of their cations and anions which means that ILs are in the liquid phase even at room temperature. ILs comprise, for example, imidazolium, pyridinium or pyrrolidinium ions as cations and, for example, TFSI as the anion.

The solid electrolyte is preferably a polymer solid-state electrolyte based on a polymer-conducting salt complex which is monophasic without any liquid component. A solid polymer electrolyte may comprise polyacrylic acid (PAA), polyethylene glycol (PEG) or polymethyl methacrylate (PMMA) as the polymer matrix. These may have lithium conducting salts such as, for example, LiTFSI, LiPF₆ and LiBF₄ dissolved in them.

If the cell is a lithium-sulfur cell, the separator may be a protective layer that protects the anode from the electrolyte and any lithium sulfides dissolved therein. This protective layer may be applied to the separator on the cathode side, for example.

The cell is preferably surrounded by a housing. The housing is preferably gas-tight. The housing may be, for example, a solid, self-supporting housing made of metal or plastic (hard case) or a housing made of a film (pouch packaging).

The open-pored structure of the matrix is of great importance. An open-pored structure refers to a structure comprising a multiplicity of pores connected to one another via channels or breaches in the pore walls. Open-pored structures therefore generally have a large internal area.

It is preferable when the cell has at least one of the immediately following additional features a. and b.:

a. the matrix has a porosity of 40% to 95%; and
b. the pores in the matrix have an average diameter of 2 to 50 μm.

It is particularly preferable when the two immediately preceding features a. and b. are realized in combination with one another.

Determination of porosities (ratio of volume of pores divided by total volume of matrix) and pore size distributions is no longer an obstacle today. There are numerous measuring instruments that perform corresponding determinations according to standardized methods. The above values refer to determinations according to the standards ISO 15901-1 and DIN 66133.

In possible developments of the immediately preceding feature a., the matrix preferably has a porosity of 50% to 95%, particularly preferably 70% to 95%, in particular 80% to 95%.

In examples of the immediately preceding feature b., the pores in the matrix preferably have an average diameter of 7.5 to 150 μm, particularly preferably 9 to 130 μm, in particular 10 to 120 μm.

The pores in the matrix are particularly preferably connected by passages having an average diameter of 0.5 μm to 50 μm, particularly preferably 1 to 40 μm, in particular 1 to 25 μm, very particularly preferably 1 to 10 μm.

The matrix ideally consists of a material that does not undergo chemical change during charging and discharging.

Particularly preferably, the cell has at least one of the immediately following additional features a. and b.:

a. the matrix comprises carbon formed by carbonization of an organic compound; and
b. the matrix comprises the carbon in a proportion of 50% to 100% by weight.

It is particularly preferable when the two immediately preceding features a. and b. are realized in combination with one another.

Particularly preferred examples of carbonizable organic compounds and also of processes for carbonization are described in EP 2 669 260 A1, the content of which is hereby fully incorporated by reference herein.

The production of the porous, electrically conductive matrix having an open-pored structure preferably proceeds from a porous organic compound, in particular from a polymer having a porous structure.

Formation of this porous organic compound, in particular, the polymer having the porous structure, is preferably carried out by polymerizing the monomer phase of a monomerwater emulsion, for example, by ring-opening metathesis polymerization (ROMP) of a diene compound amenable thereto. Water droplets are trapped during polymerization. After a subsequent removal of the water, cavities remain in their place. The resulting polymeric matrix with these cavities may be carbonized in a subsequent step, with intermediate steps such as an oxidative treatment (see below) possibly being necessary.

In this example, carbonization means conversion of an organic compound into virtually pure carbon. Such a conversion is generally carried out at very high temperatures and in the absence of oxygen.

EP 2 669 260 A1 describes formation of an unsaturated polymer having a porous structure. The starting material is at least one carbon-containing monomer, preferably at least one mono- or polycyclic diene compound, particularly preferably at least one diene compound selected from the group consisting of dicyclopentadiene, norbornene, nobornadiene, cyclooctene, cyclooctadiene and derivatives thereof. This at least one carbon-containing monomer is converted into the desired unsaturated polymer having the porous structure by ring-opening metathesis polymerization (ROMP) in a monomer phase of a monomer-water emulsion. The resulting unsaturated polymer preferably has C═C-double bonds having at least one oxidizable hydrogen atom in an α-position.

The resulting unsaturated polymer having a porous structure is subsequently subjected to a chemical and/or physical treatment and then carbonized by thermal treatment. This carbonization then results in the desired electrically conductive matrix having the open-pored structure.

The chemical and/or physical treatment preferably comprises an oxidative treatment, in particular the reaction of the unsaturated polymer in an oxidative atmosphere, preferably at temperatures of 0° C. to 250° C. The purpose of this treatment is to increase the oxygen content in the polymer prior to the subsequent carbonization, particularly preferably to a mass fraction of 25% to 40%.

For subsequent carbonization the polymer may be heated to a temperature of 550° C. to 2500° C., preferably in an oxygen-free atmosphere.

The properties of the matrix, in particular also its pore size, may also be specifically adjusted in this production example. This may be achieved by adding different amounts of a surfactant to the monomer-in-water emulsion. It is preferable when the volume fraction of the surfactant is varied from 0.1% to 8% (based on the amount of the polymerizable monomer in the emulsion).

In an example, it is preferable when the cell has at least one of the immediately following additional features a. and b.:

a. in addition to the carbon, the matrix contains at least one filler having a higher or a lower electrical conductivity than the carbon; and
b. the filler is at least one member of the group comprising carbon black, CNT, graphene, and metal particles.

It is particularly preferable when the two immediately preceding features a. and b. are realized in combination with one another.

The electrical conductivity of the matrix may be specifically increased or decreased by the filler. The filler may be introduced, for example, by adding it to the abovementioned monomer-in-water emulsion.

The matrix preferably comprises at least one filler in a proportion of 0.1% to 30% by weight.

It is further preferable when the cell has at least one of the immediately following additional features a. and b.:

a. the cell comprises an electrical conductor for making electrical contact with the anode;
b. the electrical conductor is a metal foil.

It is particularly preferable when the two immediately preceding features a. and b. are realized in combination with one another.

The electrical conductor is particularly preferably made of nickel or a nickel alloy or copper or a copper alloy.

In a possible development the cell has at least one of the immediately following additional features a. and b.:

a. the matrix of the anode forms a layer on the electrical conductor; and
b. the layer has an average thickness of 5 to 100 μm.

It is particularly preferable when the two immediately preceding features a. and b. are realized in combination with one another.

The primary function of the electrical conductor is to carry electrical current to and from the anode. It is preferable when one end of the electrical conductor is connected directly to the anode while the other end leads to a terminal of the cell that is couplable to an electrical consumer.

However, the electrical conductor especially also serves as a carrier for the electrically conductive matrix. It is preferable when the matrix covers the electrical conductor such that direct deposition of lithium on the conductor is impossible. In a cell containing a liquid electrolyte this is ensured, for example, when the matrix covers all surfaces of the conductor which could come into contact with the electrolyte.

The conductor may in principle be any desired sheetlike metal substrate, i.e., not only the abovementioned metal foil but also a metal foam in tape form or a metallic fleece in tape form. However the abovementioned foil is preferred, in particular when it is in the form of a rectangular substrate or in tape form.

The indication that the matrix is preferably in the form of a layer already implies that the anode of the lithium-sulfur cell is altogether preferably likewise in the form of a layer. Preferably, the cathode and the separator are accordingly also in the form of layers.

It is preferable when the anode, the cathode and the separator are combined with one another to form a composite body having the sequence positive electrode/separator/negative electrode. In electrodes and separators in tape form, the composite body is probably the form of a winding. However, it is also common for a plurality of composite bodies to be stacked on top of one another.

The cathode is preferably in the form of a layer having a thickness of 10 μm to 200 μm.

In particular, when the cell is a lithium-sulfur cell, the cell preferably has at least one of the immediately following additional features a. and b.:

a. the cathode comprises a porous, electrically conductive matrix having an open-pored structure; and
b. sulfur is incorporated in this matrix.

It is particularly preferable when the two immediately preceding features a. and b. are realized in combination with one another.

The matrix employed on the cathode side having the open-pored structure preferably has the same constitution and structure as the matrix employed on the anode side.

Irrespective of the active material chosen, it is preferable when the construction of the cathode is similar to the construction of the anode. It is thus preferred for the cell to have at least one of the immediately following additional features a. to c.:

a. the cathode comprises an electrical conductor for making electrical contact with the active material of the cathode;
b. the electrical conductor is a metal foil; and
c. the matrix of the cathode forms a layer on the metallic conductor.

It is particularly preferable when the two immediately preceding features a. and b. are realized in combination with one another. If the cell is a lithium-sulfur cell, it is preferable when all immediately preceding features a. to c. are realized in combination with one another.

The cell may be produced with the aid of the process described below which likewise forms part of the subject matter of this disclosure. This always comprises the immediately following steps a. to c.:

a. providing a porous, electrically conductive matrix;
b. incorporating lithium in pores of the matrix to form an anode containing the lithium as active material; and
c. combining the anode formed with a separator and a cathode containing sulfur as active material.

The three steps need not necessarily be performed in the specified sequence. Accordingly, step b. may readily be performed after step c.

The process preferably comprises the immediately following additional step a., particularly preferably a combination of the two immediately following steps a. and b.:

a. to provide the electrically conductive matrix a porous organic compound is carbonized; and
b. carbonization is carried out in the absence of oxygen.

The properties of the matrix and, in particular, preferred forms of its production, including carbonization, have already been discussed. Detailed working examples may be found in EP 2 669 260 A1.

In particular, examples of organic compounds that are processable into the porous organic compound and which, by the subsequent carbonization step, afford the porous matrix have already been recited above.

Particularly preferably, the process comprises the immediately following additional step a., particularly preferably a combination of the two immediately following steps a. and b.:

a. for the carbonization, a layer of the organic compound to be carbonized is formed on a carrier; and
b. the carrier used is a metal foil.

It is therefore preferable to initially form the layer of the porous organic compound on the carrier. To this end, the above-described monomer-in-water emulsion of a diene compound may be applied to the carrier, for example. Metathesis of the diene compound affords the porous organic compound which is subjected to the oxidative treatment likewise described above. The porous organic compound together with the carrier may subsequently be subjected to a temperature at which the carbonization occurs and the porous matrix is obtained.

Carriers that may be used include the metal substrates recited above, i.e., the so-called metal foils.

Particularly preferably, the process comprises the immediately following additional step a., particularly preferably a combination of the two immediately following steps a. and b.:

a. the metallic lithium is introduced into the pores of the matrix by electrochemical deposition; and
b. the metallic lithium is introduced into the pores of the matrix before the anode is combined with the separator and the cathode.

Introduction of the lithium into the pores of the matrix may be effected, for example, by immersing the matrix in a lithium salt solution and connecting it to the negative terminal of a DC voltage source.

Further particularly preferably, the process comprises the immediately following additional step a., particularly preferably a combination of the two immediately following steps a. and b.:

a. the metallic lithium is introduced into the pores of the matrix by electrochemical deposition; and
b. the metallic lithium is introduced into the pores of the matrix after the anode is combined with the separator and the cathode.

In this example, a lithium ion-containing NMC material may be employed on the cathode side, for example. The electrochemical deposition of the metallic lithium in the pores of the matrix is then effected during the first charging.

It is also possible to partially load the matrix with metallic lithium, combine the partially laden matrix with the cathode and the separator and effect complete loading of the matrix during the first charging. This makes it possible to introduce an excess of lithium into the cell to compensate for losses during the first charging and discharging cycles.

If the cell is a lithium-sulfur cell, it is also possible in several preferred configurations to load the cathode with lithium sulfides and connect it to a separator and a porous and electrically conductive matrix described above arranged on the electrical conductor likewise described above to afford a cell. When a charging voltage is applied to the cell, the lithium sulfide dissolves and the matrix is filled with lithium from the cathode.

Further features and advantages resulting are apparent from the following working examples and drawings. The working example described below serves merely for elucidation and better understanding and is in no way to be considered limiting.

### Working Example

(1) 8.00 mL (60 mmol) of dicyclopentadiene (Sigma-Aldrich) and 0.084 mL (1.9*10⁻² mmol) of the surfactant Pluronic® 121 (poly(ethylene glycol)-block-poly(propylene glycol)-blockpoly(ethylene glycol); Mₙ=4400 g/mol; Sigma-Aldrich) were initially charged into a reaction vessel. The mixture of the two components was stirred at 400 rpm. 33 mL of deionized water were added dropwise with constant stirring. After addition of the water the mixture was stirred for a further hour until a uniform emulsion was obtained. At the end of the stirring operation the emulsion was admixed with an initiator (8 mg (8.4*10⁻³ mmol) of N,N-bis(mesityl)-4,5-dihydroimidazol-2-yl; Sigma-Aldrich) dissolved in 1 mL of toluene.
(2) The emulsion resulting from step (1) was applied in a layer thickness of 100 μm to a copper foil of 12 μm in thickness. The resulting layer was then heated to 80° C. with the copper foil. Curing for 4 hours afforded a layer which was white and mechanically stable. This layer was washed repeatedly with dichloromethane and acetone and dried under vacuum.
(3) The layer resulting from step (2) was exposed to atmospheric oxygen at room temperature for four weeks. At the end of the 4 weeks the oxygen content in the layer was 31.54% (determined by elemental analysis).
(4) In a subsequent step the copper foil comprising the layer was exposed to a temperature of 900° C. in an argon atmosphere for 2 hours. This caused the layer to carbonize.
(5) A 1.13 cm² section was cut out of the copper foil coated with the carbonized layer and installed in a Swagelok cell as the negative electrode and cycled at a C charging rate of 0.1 and a C discharging rate of 0.1. During the first charging metallic lithium was deposited in the pores of the anode.

The positive electrode employed was an NMC cathode (active material lithium nickel manganese cobalt oxide (LiNi_{0.33}Mn_{0.33}Co_{0.33}O₂)) and the electrolyte employed was a mixture of EC and EMC (volume ratio 3:7) with an addition of 2% by volume of vinylene carbonate (VC) and 1M LiPF₆. The separator employed was a commercially available polyolefin separator.

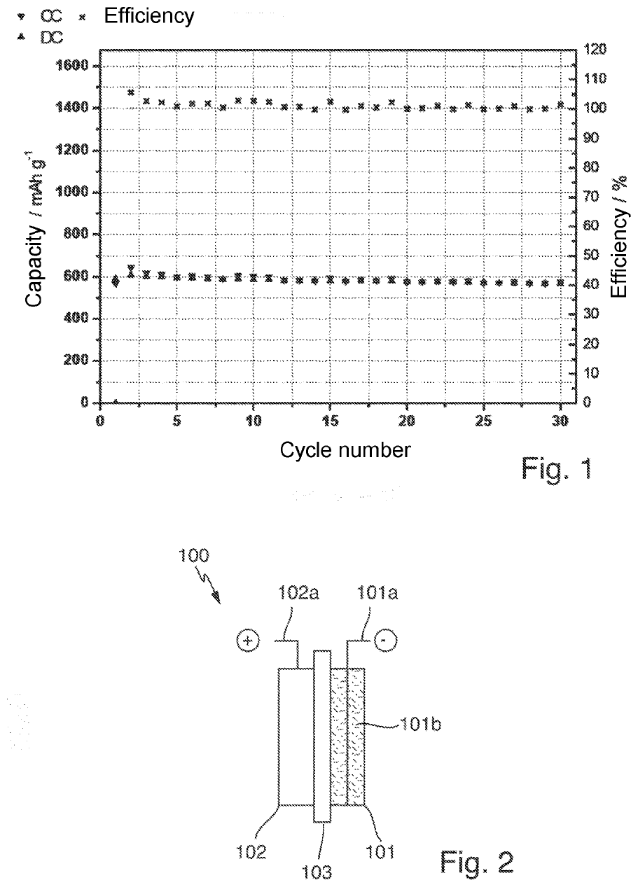

The cycling results are shown in FIG. 1. As is readily apparent, virtually no capacity reduction was observed in the course of the cycling tests.

FIG. 2 is a schematic diagram of an example of a cell 100. The cell comprises the anode 101, the cathode 102 and the separator 103. The cell 100 comprises an electrical conductor 101a for making electrical contact with the anode 101 and an electrical conductor 102a for making electrical contact with the cathode 102. Both the electrical conductor 101a and the electrical conductor 102a are metal foils. The anode 101 comprises a porous, electrically conductive matrix 101b having an open-pored structure, in whose pores lithium is incorporated.

1-13. (canceled)

14. An electrochemical cell comprising:
a. a cathode capable of reversibly accommodating lithium ions;
b. an anode containing metallic lithium as active material; and
c. a separator arranged between the cathode and the anode,
wherein
d. the anode comprises a porous, electrically conductive matrix having an open-pored structure; and
e. the metallic lithium of the anode is incorporated in pores of the matrix.

15. The cell as claimed in claim 14, wherein at least one of:
a. the matrix has a porosity of 40% to 95%; and
b. the pores in the matrix have an average diameter of 2 to 50 μm.

16. The cell as claimed in claim 14, wherein at least one of:
a. the matrix comprises carbon formed by carbonization of an organic compound; and
b. the matrix comprises the carbon in a proportion of 50% to 100% by weight.

17. The cell as claimed in claim 16, wherein at least one of:
a. in addition to the carbon, the matrix contains at least one filler having a higher or a lower electrical conductivity than the carbon; and
b. the filler is at least one member selected from the group consisting of carbon black, CNT, graphene, and metal particles.

18. The cell as claimed in claim 14, wherein at least one of:
a. the cell comprises an electrical conductor that electrically contacts the anode; and
b. the electrical conductor is a metal foil.

19. The cell as claimed in claim 18, wherein at least one of:
a. the matrix of the anode forms a layer on the electrical conductor; and
b. the layer has an average thickness of 5 to 100 μm.

20. The cell as claimed in claim 14, wherein
a. the cathode comprises a porous, electrically conductive matrix having an open-pored structure; and
b. sulfur is incorporated in the matrix.

21. The cell as claimed in claim 20, wherein
a. the cathode comprises an electrical conductor that electrically contacts the active material of the cathode;
b. the electrical conductor is a metal foil; and
c. the matrix of the cathode forms a layer on the metallic conductor.

22. A process of producing the electrochemical cell comprising:
a. providing a porous, electrically conductive matrix;
b. incorporating lithium in pores of the matrix to form an anode containing the lithium as active material; and
c. combining the anode formed with a separator and a cathode containing sulfur as active material.

23. The process as claimed in claim 22, further comprising:
a. providing the electrically conductive matrix a porous organic compound is carbonized; and
b. carrying out the carbonization in the absence of oxygen.

24. The process as claimed in claim 23, wherein
a. for the carbonization a layer of the porous organic compound to be carbonized is formed on a carrier; and
b. the carrier used is a metal foil.

25. The process as claimed in claim 22, further comprising:
a. introducing the metallic lithium into the pores of the matrix by electrochemical deposition; and
b. introducing the metallic lithium into the pores of the matrix before the anode is combined with the separator and the cathode.

26. The process as claimed in claim 22, further comprising:
a. introducing the metallic lithium into the pores of the matrix by electrochemical deposition; and
b. introducing the metallic lithium into the pores of the matrix after the anode is combined with the separator and the cathode.
